(19) United States
(12) Patent Application Publication
(10) Pub. No.: US 2005/0279220 A1
(43) Pub. Date: Dec. 22, 2005

(54) Cup and filter combination

(76) Inventor: John C. Cheng, Irvine, CA (US)

Correspondence Address: John Cheng, 2 Vetrina, Irvine, CA, 92606, US

(21) Appl. No.: 10/870,861

(22) Filed: Jun. 18, 2004

(51) Int. Cl. A23F 3/00

(52) U.S. Cl. 99/323

(57) ABSTRACT

The present invention provides a cup and filter combination comprising a foldable filter inside the cup. The combination further comprises a foldable retaining ring for holding the filter within the cup. The foldable retaining ring is attached to the filter along the outer edge of the filter and is attached to the inner wall of the cup to hold the filter within the cup. In a folded configuration, the retaining ring and the filter are folded inside the cup. In an open configuration, the retaining ring is pulled open from its folded configuration. In this configuration, the retaining ring has a ring shape that runs along the inner circumference of cup and the filter is opened up to receive tealeaves or coffee grounds to be brewed and filtered. The invention is not limited to brewed beverages and can also be used to filter particulate matter from a liquid.

### BACKGROUND OF THE INVENTION

1. Field of Invention

The present invention relates generally to a cup and filter combination, and more particularly, to a cup and filter combination comprising a foldable filter inside the cup.

2. Description of the Related Arts

A tea drinker has several options available to him/her for preparing a cup of freshly brewed tea. In one option, the tea drinker positions the cup beneath a tea filter containing tealeaves and pours hot water into the filter to brew the tealeaves. The resulting brewed tea passes through the filter into the cup. The tea filter may be a filter basket comprising a wire mesh or a paper filter held above the cup by a filter holder. A disadvantage of this option is that the tea can spill out of the filter onto countertops, tables and floors. Another disadvantage is that the filter and/or filter holder has to be cleaned.

In another option, the tea drinker steeps a tea bag into a cup of hot water. A disadvantage of this option is that the tea bag contains a fixed quantity of tealeaves, which does not allow the tea drinker to specify the quantity of tealeaves according to his/her taste. Another disadvantage is that many tea drinkers prefer to buy tealeaves in bulk containers instead of in individualized tea bags.

Therefore, there remains a need for an article that provides brewed tea in a cup while avoiding the disadvantages associated with the prior art tea filters and/or tea bags.

### BRIEF SUMMARY OF THE INVENTION

The present invention provides a cup and filter combination comprising a foldable filter inside the cup. The combination further comprises a foldable retaining ring for holding the foldable filter within the cup. The foldable retaining ring is attached to the filter along the outer edge of the filter and is attached to the inner wall of the cup to hold the filter within the cup.

In a folded configuration, the retaining ring and the filter are folded inside the cup. In an open configuration, the retaining ring is pulled open from its folded configuration. In this configuration, the retaining ring has a ring shape and the filter is opened up to receive tealeaves to be brewed and filtered.

To prepare a cup of tea, a tea drinker pulls open the retaining ring from the folded configuration to the open configuration. The tea drinker then places tealeaves of a desired amount in the filter, and pours hot water into the filter to brew tea. After brewing the tea for a desired time, the tea drinker pulls the retaining ring back to the folded configuration with the residual tealeaves remaining in the filter. The tea drinker can then drink the filtered tea from a rim of the cup located away from the filter. Alternatively, the tea drinker can remove the filter before drinking the tea by pulling or peeling the retaining ring off of the cup.

The cup and filter combination of the invention offers several advantages. One advantage is that it allows a tea drinker to conveniently prepare a cup of tea without the need to provide a separate filter. The tea drinker simply pulls open the folded filter inside the cup to filter the tea. Another advantage is that the invention reduces spillage from the filter onto countertops, tables and floors because the filter is located inside the cup. An advantage over tea bags is that the tea drinker can specify the quantity of tealeaves that goes into the filter according to his/her taste.

The invention is not limited to brewing tea and can be used to brew other beverages such as coffee. In addition, the invention can be used to filter out particulate matter from a liquid.

The features and advantages described in the specification are not all inclusive and, in particular, many additional features and advantages will be apparent to one of ordinary skill in the art in view of the drawings, specification, and the claims.

### BRIEF DESCRIPTION OF THE DRAWINGS

FIG. 1 shows a perspective view of a cup and filter combination in a folded configuration according to an embodiment of the invention.

FIG. 2 shows the filter in FIG. 1 with the cup removed for ease of illustration.

FIG. 3 shows a perspective view of the cup and filter combination in an open configuration.

FIG. 4 shows the filter in FIG. 3 with the cup removed for ease of illustration.

FIG. 5 is a flowchart showing a method of preparing a cup of tea using the cup and filter combination of the invention.

### DETAILED DESCRIPTION OF THE PRESENT INVENTION

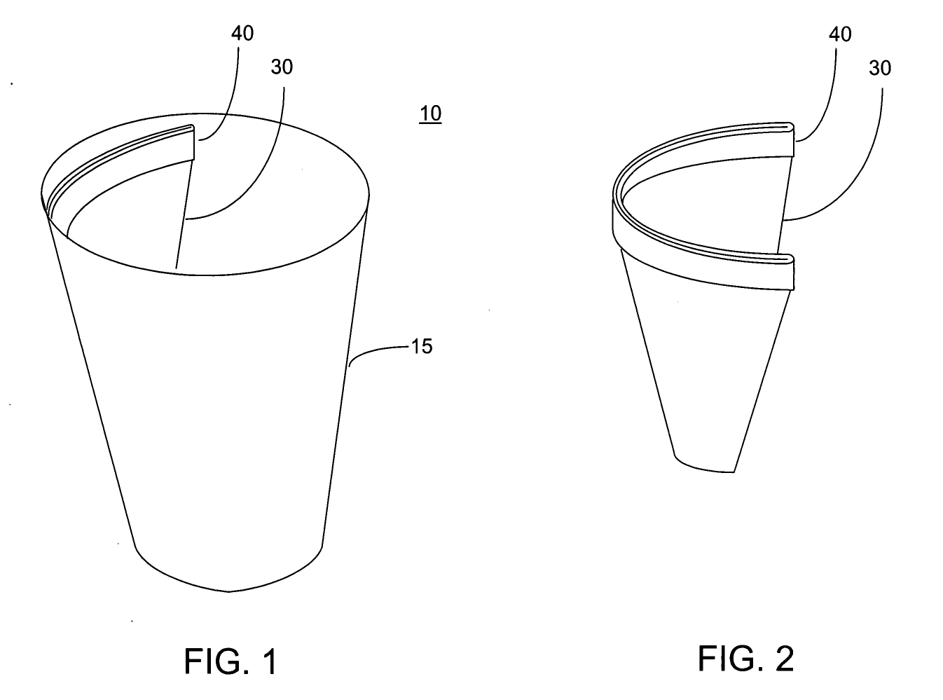

FIG. 1 shows a perspective view of a cup and filter combination 10 in accordance with an embodiment of the invention. The combination 10 comprises a cup 15 for retaining a beverage, for example, brewed tea or coffee. The cup 15 may be a disposable cup made of cardboard, plastic, Styrofoam, polystyrene or the like.

The combination 10 also comprises a foldable filter 30 inside the cup 15. FIG. 2 shows the filter 30 with the cup 15 removed for ease of illustration. The filter 30 can be made of a porous liquid permeable material, a screen or the like. For brewing tea, the filter 30 may be made of tea filter material that retains tealeaves within the filter 30 while allowing the brewed tea to pass through the filter 30. The tea filter material may be similar to filter material used in tea bags and/or tea filter paper. For brewing coffee, the filter 30 may be made of coffee filter paper.

The combination further comprises a foldable retaining ring 40 for holding the filter 30 within the cup. The retaining ring 40 is attached to the filter 30 along the outer edge of the filter 30. The foldable retaining ring 40 may be attached to the filter 30 using a water resistant adhesive and/or a seam. The foldable retaining ring 40 is preferably made of flexible material, for example, cardboard or plastic. An outer portion of the retaining ring 40 is attached to the inner wall of the cup 15 to hold the filter 30 within the cup 15. The outer portion of the retaining ring 40 may be attached to the cup 15 along the inner circumference of the cup 15, for example, using an adhesive.

FIG. 2 shows the filter 30 in a folded configuration, in which the retaining ring 40 is folded flat along the inner wall of the cup 15. FIG. 1 shows the filter 30 inside the cup 15 in the folded configuration. In this configuration, the filter 30 is folded flat, which allows other cups to be placed inside the cup 15 for compact storage of the cups in a stack.

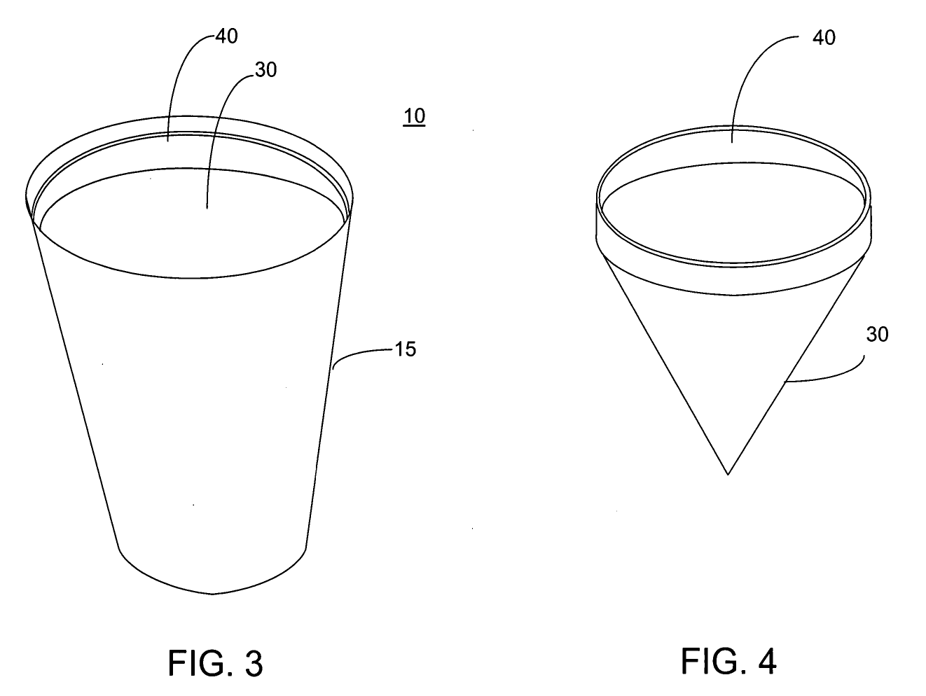

FIG. 4 shows the filter 30 in an open configuration, in which the retaining ring 40 is pulled open. The retaining ring 40 may include an optional tab 45 to provide a firm grip for pulling the retaining ring 40 open. FIG. 3 shows the filter 30 inside the cup 15 in the open configuration. In this configuration, the retaining ring 40 has a ring shape that runs along the inner circumference of cup 15. Preferably, the flexible material of the retaining ring 40 has enough rigidity so that the retaining ring 40 retains its ring shape when pulled open. This can be accomplished, for example, by using thin cardboard for the flexible material of the retaining ring 40. The retaining ring 40 may be constructed by taking a strip of cardboard, bending the strip of cardboard into a ring shape and connecting the two ends of the strip of cardboard with, for example, an adhesive. In the open configuration, the filter 30 is opened up for receiving tealeaves or coffee grounds to be brewed and filtered. The filter 30 can take on other shapes besides the ones shown in the figures. For example, the filter 30 can have a basket shape instead of a conical shape in the open configuration.

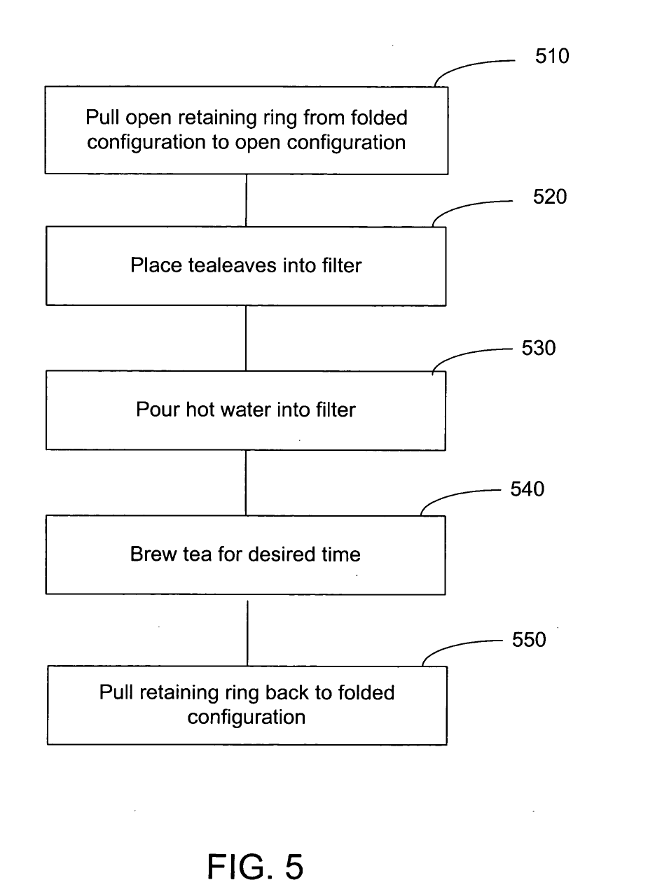

A method for brewing tea using the cup and filter combination 10 of the invention will now be described with reference to FIG. 5. In step 510, a tea drinker pulls open the retaining ring 40 from the folded configuration to the open configuration. In step 520, the tea drinker places tealeaves of a desired amount in the filter 30. The tea drinker may spoon the tealeaves into the filter 30 from a container of loose tea. In step 530, the tea drinker pours hot water into the filter 30 to brew tea. In step 540, the tea drinker brews the tea for a desired time. In step 550, the tea drinker pulls the retaining ring 40 back to the folded configuration. The residual tealeaves remain in the filter 40 with the brewed tea filling the cup 15. At this point, the tea drinker can drink the filtered tea, for example, by placing his/her mouth on a rim 50 of the cup 15 located away from the filter 30 and sipping the tea.

Alternatively, the tea drinker can remove the filter 30 from the cup 15 before drinking the tea. The tea drinker can do this by pulling or peeling the retaining ring 40 off of the cup 15. For this embodiment, the retaining ring 40 may be attached to the cup 15 by an adhesive that allows the retaining ring 40 to be pulled off the cup 15 without damaging the cup 15.

The above-described method for brewing tea can also be used to brew other beverages, for example, coffee. To brew coffee, a coffee drinker places coffee grounds in the filter, and pours hot water into the filter 30. The coffee drinker may control the amount of hot water so that the level of the filtered coffee does not reach the bottom of the filter 30. This way, the brewed coffee drips from the bottom of the filter 30 and the filter 30 is not submersed in the filtered coffee in the cup 15.

The cup and filter combination can be used in other applications besides brewing beverages such as separating particulate matter from a liquid. For example, the liquid containing the particulate matter can be placed in the filter 30 to filter out the particulate matter from the liquid. In this embodiment, the filter 30 is made of a material that blocks the particulate matter while allowing the liquid to pass through the filter 30.

Those skilled in the art will appreciate that various adaptations and modifications of the just-described preferred embodiments of the invention can be configured without departing from the scope and spirit of the invention. Therefore, it is to be understood that, within the scope of he appended claims, the invention may be practiced other than as specifically described herein.

1. A cup and filter combination comprising:
a cup;
a foldable filter within the cup; and
a foldable retaining ring attached to the filter along an outer edge of the filter and attached to an inner wall of the cup for holding the filter within the cup;
wherein the foldable retaining ring has a ring shape in an open configuration and can be folded flat in a folded configuration.

2. The cup and filter combination of claim 1, wherein the retaining ring is made substantially of cardboard or plastic.

3. The cup and filter combination of claim 1, wherein the retaining ring can be folded flat along an inner wall of the cup in the folded configuration.

4. The cup and filter combination of claim 1, wherein the retaining ring further comprises a tab for pulling the retaining ring open from the folded configuration to the open configuration.

5. The cup and filter combination of claim 1, wherein the filter comprises tea filter paper.

6. The cup and filter combination of claim 1, wherein the filter comprises coffee filter paper.
